(19) United States
(12) Patent Application Publication
(10) Pub. No.: US 2026/0241876 A1
(43) Pub. Date: Aug. 20, 2026

(54) VIBRATION-ISOLATION AND SOUND-ISOLATION APPARATUS, BRACKET WITH VIBRATION-ISOLATION AND SOUND-ISOLATION FUNCTION, AND FIXING STRUCTURE FOR VEHICLE ELECTRIC AUXILIARY MACHINE

(71) Applicant: Sumitomo Riko Company Limited, Aichi (JP)

(72) Inventors: Takayoshi Yasuda, Aichi (JP); Toshiki Matsuoka, Aichi (JP); Nobuyoshi Seto, Aichi (JP)

(73) Assignee: Sumitomo Riko Company Limited, Aichi (JP)

(21) Appl. No.: 19/641,489

(22) Filed: Apr. 7, 2026

Related U.S. Application Data
(63) Continuation of application No. PCT/JP2024/043492, filed on Dec. 10, 2024.

(30) Foreign Application Priority Data
Dec. 18, 2023 (JP) 2023-212608

(51) Int. Cl. B60R 13/08; F16F 15/08

(52) U.S. Cl. CPC B60R 13/0884; F16F 15/08

(57) ABSTRACT

Provided is a vibration-isolation and sound-isolation device which is attached to a vehicle electric auxiliary machine, said vibration-isolation and sound-isolation device comprising: a bracket body which is attached to the vehicle electric auxiliary machine; a vibration-isolation device which is attached to the bracket body and which elastically couples the bracket body and a vehicle body of a vehicle; and a sound-isolation cover which is attached to the bracket body, the vibration-isolation device, or the vehicle electric auxiliary machine and which covers the vehicle electric auxiliary machine in a non-contact manner.

### CROSS-REFERENCE TO RELATED APPLICATION

The present application is a continuation of PCT/JP2024/043492, filed on December 10, 2024, and is related to and claims priority from Japanese Patent Application No. 2023-212608 filed on December 18, 2023. The entire contents of the aforementioned application are hereby incorporated by reference herein.

### TECHNICAL FIELD

The disclosure relates to a vibration-isolation and sound-isolation apparatus, a bracket with a vibration-isolation and sound-isolation function, and a fixing structure for a vehicle electric auxiliary machine.

### BACKGROUND ART

Recently, with the widespread adoption of EVs (Electric Vehicle), the quietness inside the vehicle cabin has improved, making the sound and vibration generated during operation of the vehicle electric auxiliary machine mounted on the vehicle a problem.

When a vehicle electric auxiliary machine is in operation, operating sound may be generated from the vehicle electric auxiliary machine. In the case of such operating sound entering the vehicle cabin, it may become noise for the occupants. Further, when a vehicle electric auxiliary machine is in operation, the vehicle electric auxiliary machine may vibrate. As this vibration is transmitted to a bracket that connects the vehicle electric auxiliary machine and the vehicle body of the vehicle, and further transmitted to the vehicle body of the vehicle, the vehicle electric auxiliary machine, the bracket, and the vehicle body of the vehicle may vibrate, which as a result causes sound to be generated from the vehicle electric auxiliary machine, the bracket, and the vehicle body of the vehicle.

In Patent Document 1 (Japanese Patent Application Laid-Open No. 2022-147641), a technology is described in which, in order to reduce the sound and vibration generated during operation of a vehicle electric auxiliary machine, the outer peripheral surface of the vehicle electric auxiliary machine is covered with a sound-isolation cover, and a vibration-isolation material is interposed between the bracket that attaches the vehicle electric auxiliary machine to the vehicle body of the vehicle and the vehicle body of the vehicle.

In the technology according to Patent Document 1, the vehicle electric auxiliary machine is fixed to the vehicle body of the vehicle by a support bracket. The vibration-isolation material is interposed between the support bracket and the vehicle body. The sound-isolation cover has a first cover portion and a second cover portion. The first cover portion is disposed between the support bracket and the vehicle body. The second cover portion covers the outer peripheral surface of the vehicle electric auxiliary machine on the opposite side from the vehicle body with respect to the support bracket. The entire vehicle electric auxiliary machine is covered by the first cover portion and the second cover portion.

In the above technology, however, the inner peripheral surface of the sound-isolation cover is in contact with the outer peripheral surface of the vehicle electric auxiliary machine. Therefore, when the vehicle electric auxiliary machine is in operation, vibration generated in the vehicle electric auxiliary machine may be transmitted to the sound-isolation cover, and the sound-isolation cover may vibrate. There is a problem that when the sound-isolation cover vibrates, sound is generated from the sound-isolation cover itself.

Additionally, in the above technology, the members used to attach the vehicle electric auxiliary machine to the vehicle body of the vehicle include the support bracket, the vibration-isolation material, and the sound-isolation cover. Therefore, there is a problem that the number of parts is large.

The disclosure provides a vibration-isolation and sound-isolation apparatus, a bracket with a vibration-isolation and sound-isolation function, and a fixing structure for a vehicle electric auxiliary machine that solve any of the above problems.

### SUMMARY

One aspect of the disclosure is a vibration-isolation and sound-isolation apparatus, attached to a vehicle electric auxiliary machine, the vibration-isolation and sound-isolation apparatus including: a bracket body attached to the vehicle electric auxiliary machine; a vibration-isolation device attached to the bracket body and elastically connecting the bracket body and a vehicle body of a vehicle; and a sound-isolation cover attached to the bracket body, the vibration-isolation device, or the vehicle electric auxiliary machine and covering the vehicle electric auxiliary machine in a non-contact state.

Another aspect of the disclosure is a fixing structure for a vehicle electric auxiliary machine, using the above vibration-isolation and sound-isolation apparatus.

Yet another aspect of the disclosure is a bracket with a vibration-isolation and sound-isolation function, attached to a vehicle electric auxiliary machine, the bracket with a vibration-isolation and sound-isolation function including:

a bracket body having a first main surface to which the vehicle electric auxiliary machine is attached;

a sound-isolation cover attached to the bracket body and covering at least a part of the vehicle electric auxiliary machine on the first main surface side of the bracket body; and

a vibration-isolation device attached to the bracket body and elastically connecting the bracket body and a vehicle body of the vehicle.

According to one aspect and another aspect of the disclosure, vibration generated by operation of the vehicle electric auxiliary machine is transmitted from the vehicle electric auxiliary machine to the bracket body, and then attenuated by the vibration-isolation device attached to the bracket body. This suppresses transmission of vibration generated in the vehicle electric auxiliary machine to the vehicle body of the vehicle. Further, sound generated by operation of the vehicle electric auxiliary machine is absorbed by the sound-isolation cover covering the vehicle electric auxiliary machine. Furthermore, since the sound-isolation cover and the vehicle electric auxiliary machine are in a non-contact state, transmission of vibration from the vehicle electric auxiliary machine to the sound-isolation cover is suppressed. This suppresses generation of sound from the sound-isolation cover due to vibration transmitted from the vehicle electric auxiliary machine.

According to yet another aspect of the disclosure, since the bracket body, the vibration-isolation device, and the sound-isolation cover can be handled as one component, the number of parts can be reduced compared to a case where the bracket body portion, the vibration-isolation device, and the sound-isolation cover are handled as separate components.

It is noted that the reference numerals in parentheses described in the claims show the correspondence relationship with the specific means described in the embodiments described later, and are not intended to limit the technical scope of the disclosure.

### BRIEF DESCRIPTION OF THE DRAWINGS

FIG. 1 is an exploded side view showing the vibration-isolation and sound-isolation apparatus according to Embodiment 1.

FIG. 2 is a side view showing the vibration-isolation and sound-isolation apparatus according to Embodiment 1.

FIG. 3 is a front view showing the vibration-isolation and sound-isolation apparatus according to Embodiment 1.

FIG. 4 is a plan view showing the vibration-isolation and sound-isolation apparatus according to Embodiment 1.

FIG. 5 is a side view showing a state where the second cover is not assembled to the first cover in the vibration-isolation and sound-isolation apparatus according to Embodiment 1.

FIG. 6 is a cross-sectional view taken along line VI-VI in FIG. 3.

FIG. 7 is a partially cutaway side cross-sectional view showing the vibration-isolation and sound-isolation apparatus according to Embodiment 1.

FIG. 8 is a partially cutaway side cross-sectional view showing the vibration-isolation and sound-isolation apparatus according to Embodiment 2.

FIG. 9 is a partially cutaway side cross-sectional view showing the vibration-isolation and sound-isolation apparatus according to Embodiment 3.

FIG. 10 is a partially cutaway side cross-sectional view showing the vibration-isolation and sound-isolation apparatus according to Embodiment 4.

FIG. 11 is a side view showing the vibration-isolation and sound-isolation apparatus according to Embodiment 5.

FIG. 12 is a side view showing the vibration-isolation and sound-isolation apparatus according to Embodiment 6.

FIG. 13 is a side view showing the vibration-isolation and sound-isolation apparatus according to Embodiment 7.

FIG. 14 is a side view showing the vibration-isolation and sound-isolation apparatus according to Embodiment 8.

FIG. 15 is a cross-sectional view showing the vibration-isolation and sound-isolation apparatus according to Embodiment 9, corresponding to line VI-VI in FIG. 3.

FIG. 16 is a front view showing the vibration-isolation and sound-isolation apparatus according to Embodiment 10.

FIG. 17 is a side view showing the vibration-isolation and sound-isolation apparatus according to Embodiment 10.

FIG. 18 is a cross-sectional view showing the vibration-isolation and sound-isolation apparatus according to Embodiment 10, corresponding to line VI-VI in FIG. 3.

### DESCRIPTION OF THE EMBODIMENTS

### Embodiment 1

### 1. Schematic configuration of vibration-isolation and sound-isolation apparatus 10a

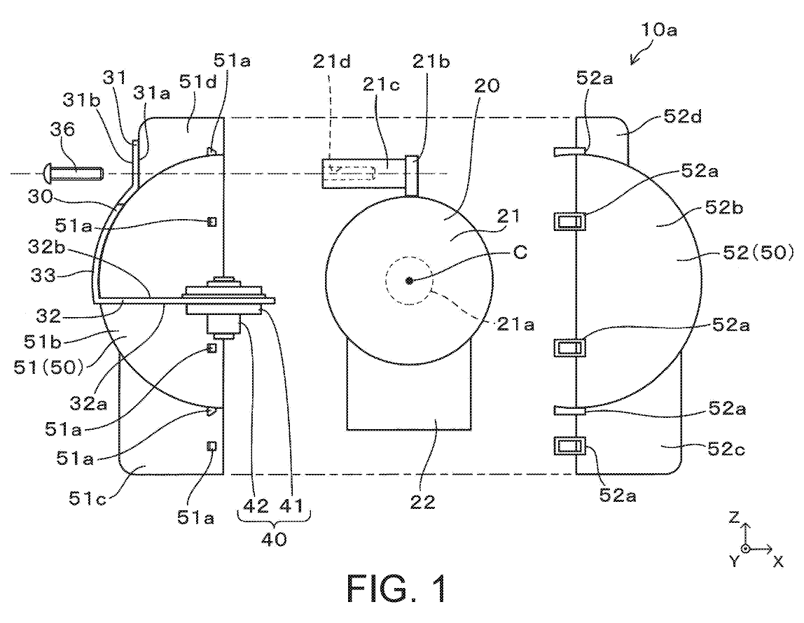

As shown in FIG. 1, a vibration-isolation and sound-isolation apparatus 10a (an example of a bracket with a vibration-isolation and sound-isolation function, an example of a fixing structure for a vehicle electric auxiliary machine 20) according to the present embodiment is attached to a vehicle electric auxiliary machine 20, and has a function of suppressing transmission of vibration generated by the vehicle electric auxiliary machine 20 to a vehicle body B of a vehicle (not shown) and a function of suppressing transmission of noise generated by the vehicle electric auxiliary machine 20 to the outside. The vibration-isolation and sound-isolation apparatus 10a according to the present embodiment may be applied to any vehicle electric auxiliary machine 20 such as motor and compressor. In the present embodiment, a compressor will be described as an example of the vehicle electric auxiliary machine 20. In the following description, the direction indicated by arrow X is described as forward, the direction indicated by arrow Y is described as leftward, and the direction indicated by arrow Z is described as upward. Further, in the following description, for multiple identical members, reference numerals may be assigned to only some of the members and omitted for other members.

### 2. Vehicle electric auxiliary machine 20

As shown in FIG. 1, the vehicle electric auxiliary machine 20 includes a body portion 21 and a protruding portion 22 that protrudes downward from the outer surface of the body portion 21. The body portion 21 is formed in a substantially cylindrical shape. The protruding portion 22 is formed in a substantially rectangular shape. The body portion 21 accommodates a rotating shaft member 21a that rotates around a rotation axis C. The rotation axis C of the rotating shaft member 21a extends in the left-right direction. However, the shape of the body portion 21 is not particularly limited, and any shape may be adopted. The shape of the protruding portion 22 is not particularly limited, and any shape may be adopted. Further, the protruding portion 22 can be formed to protrude in any direction.

The protruding portion 22 accommodates, for example, a circuit board (not shown). However, the member accommodated in the protruding portion 22 is not limited to a circuit board, and any member can be accommodated therein.

A boss base portion 21b that protrudes upward is formed on the upper surface of the body portion 21. The boss base portion 21b is formed in a plate shape. A boss 21c that protrudes rearward is formed on the left side surface of the boss base portion 21b. The boss 21c is formed in a cylindrical shape. The boss 21c extends in the front-rear direction and has a female screw hole 21d that opens rearward.

### 3. Vibration-isolation and sound-isolation apparatus 10a

The vibration-isolation and sound-isolation apparatus 10a will be described with reference to FIG. 1 to FIG. 4. The vibration-isolation and sound-isolation apparatus 10a includes a bracket body 30, a vibration-isolation device 40, and a sound-isolation cover 50.

### 3.1. Bracket body 30

The bracket body 30 is made of metal such as aluminum and stainless steel. The bracket body 30 is formed into a predetermined shape by bending or casting a metal plate material. In the present embodiment, the bracket body 30 is obtained by bending a metal plate material.

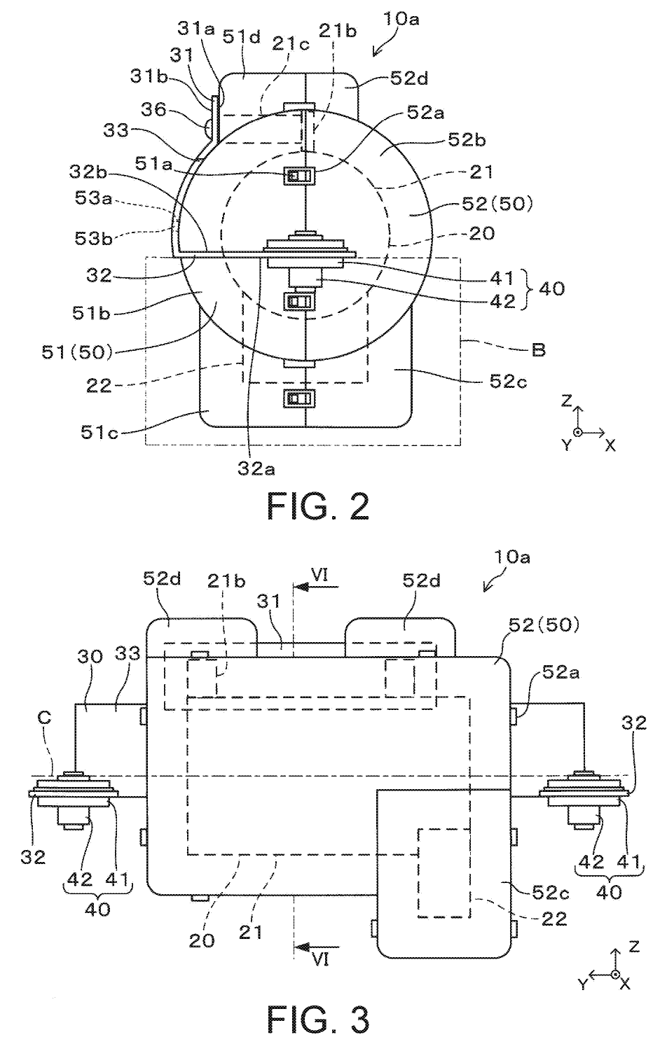

As shown in FIG. 2, the bracket body 30 includes a first mounting portion 31 that is attached to the vehicle electric auxiliary machine 20, a second mounting portion 32 that is attached to the vehicle body B of the vehicle, and a third mounting portion 33 to which the sound-isolation cover 50 is attached. The first mounting portion 31, the second mounting portion 32, and the third mounting portion 33 are integrally formed.

As shown in FIG. 1 to FIG. 4, the first mounting portion 31 extends in the rotation axis C direction of the rotating shaft member 21a (the left-right direction in the present embodiment). The first mounting portion 31 according to the present embodiment is formed in a rectangular shape, with the left-right direction as the longitudinal direction and the up-down direction as the transverse direction. Further, the first mounting portion 31 has a first main surface 31a that is attached to the vehicle electric auxiliary machine 20. In the present embodiment, the front surface of the first mounting portion 31 serves as the first main surface 31a. A surface of the first mounting portion 31 on the opposite side from the first main surface 31a (a rear surface in the present embodiment) serves as a first back surface 31b.

The third mounting portion 33 is formed extending downward from the lower end portion of the first mounting portion 31. The third mounting portion 33 is formed in a substantially rectangular shape, with the left-right direction as the longitudinal direction and the up-down direction as the transverse direction. The sound-isolation cover 50 is attached to the first main surface 31a that is continuous from the first mounting portion 31 in the third mounting portion 33. The third mounting portion 33 is formed in a gentle curved shape that is convex toward the rear. The front surface of the third mounting portion 33 forms a part of the circumference.

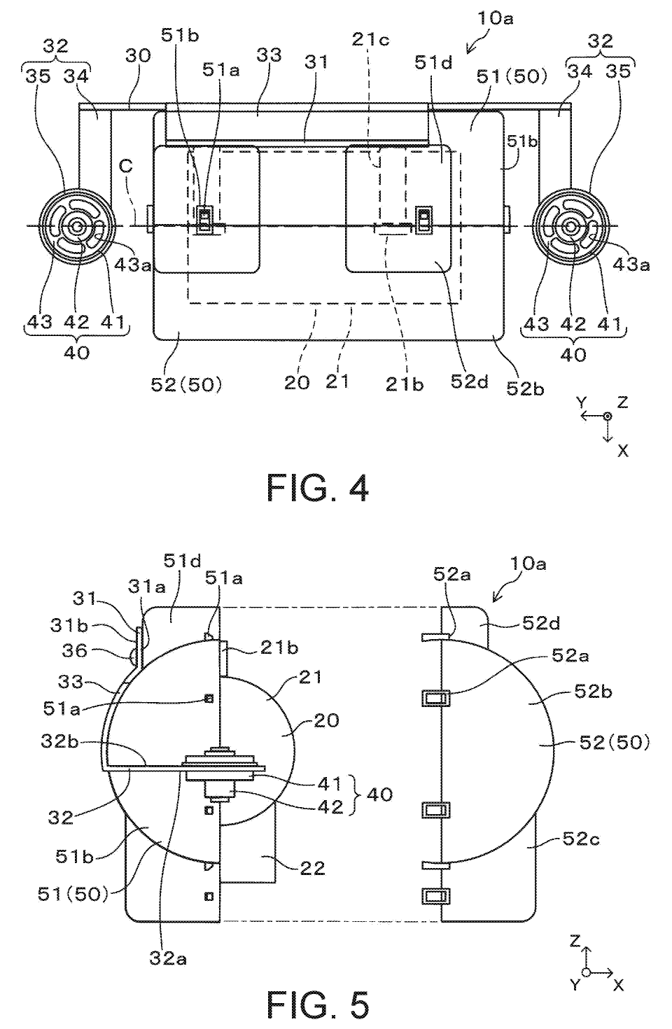

As shown in FIG. 3 to FIG. 4, the second mounting portions 32 that protrude forward are formed at both left and right end portions of the third mounting portion 33 and at the lower end edge of the third mounting portion 33. The second mounting portion 32 includes an extension portion 34 formed in a rectangular shape as viewed from above, and a vibration-isolation device mounting portion 35 formed at the front end portion of the extension portion 34 and formed in a disc shape as viewed from above. The rear end portion of the extension portion 34 is continuous with the third mounting portion 33, and the front end portion of the extension portion 34 is continuous with the vibration-isolation device mounting portion 35.

As shown in FIG. 4, the length dimension in the front-rear direction of the extension portion 34 is set such that the center of the vibration-isolation device mounting portion 35 is disposed at a position that substantially overlaps with the rotation axis C as viewed from above. The center of the vibration-isolation device mounting portion 35 and the rotation axis C may be disposed at positions that overlap as viewed from above, or may be disposed at positions that can be recognized as substantially overlapping even if the positions do not completely overlap as viewed from above.

In the present embodiment, the two second mounting portions 32 are disposed on both end sides in the rotation axis C direction of the rotating shaft member 21a with respect to the vehicle electric auxiliary machine 20. However, for example, the two second mounting portions 32 may both be disposed on one end side in the rotation axis C direction of the rotating shaft member 21a with respect to the vehicle electric auxiliary machine 20, and the second mounting portions 32 can be disposed at any positions. In addition, the number of second mounting portions 32 is not particularly limited, and may be one, or three or more.

The second mounting portion 32 has a second main surface 32a that is attached to the vehicle body B of the vehicle. In the present embodiment, the second main surface 32a is the lower surface of the second mounting portion 32. Further, a surface of the second mounting portion 32 on the opposite side from the second main surface 32a (the upper surface in the present embodiment) serves as a second back surface 32b. In the present embodiment, the first main surface 31a and the second main surface 32a constitute surfaces on the opposite sides of the bracket body 30. Additionally, in the present embodiment, the first main surface 31a and the second back surface 32b are connected at an angle.

### 3.2. Vibration-isolation device 40

As shown in FIG. 4, the vibration-isolation device 40 is attached to the vibration-isolation device mounting portion 35 of the second mounting portion 32 by penetrating in the up-down direction. The vibration-isolation device 40 includes an outer cylinder 41, an inner cylinder 42 disposed inward (inside) of the outer cylinder 41, and an elastic body 43 disposed between the outer cylinder 41 and the inner cylinder 42 and connecting the outer cylinder 41 and the inner cylinder 42.

The outer cylinder 41 and the inner cylinder 42 are made of a hard material such as metal or synthetic resin. The outer cylinder 41 and the inner cylinder 42 are formed in a substantially cylindrical shape. The length dimension in the up-down direction of the inner cylinder 42 is set larger than the length dimension in the up-down direction of the outer cylinder 41.

The outer cylinder 41 is attached to the vibration-isolation device mounting portion 35 provided on the second mounting portions 32 of the bracket body 30. The inner cylinder 42 is attached to the vehicle body B of the vehicle. A bolt (not shown) is inserted into the inner cylinder 42 from above, and the inner cylinder 42 and the vehicle body B are fixed by the bolt screwed into a nut (not shown) disposed on the vehicle body B or a female screw hole (not shown) formed in the vehicle body B.

The elastic body 43 is made of rubber or elastomer and has multiple (four in the present embodiment) undercut portions 43a penetrating in the up-down direction. The undercut portion 43a is formed in a flat shape in which the radial direction is shorter than the circumferential direction of the elastic body 43. However, the number of undercut portions 43a may be two to three, or five or more.

With the vibration-isolation device 40 interposed between the bracket body 30 and the vehicle body B, the bracket body 30 and the vehicle body B are elastically connected by the vibration-isolation device 40.

As shown in FIG. 3, the vibration-isolation device 40 is positioned near both ends on the rotation axis C of the vehicle electric auxiliary machine 20. Thereby, vibration generated from the vehicle electric auxiliary machine 20 during rotation of the rotating shaft member 21a around the rotation axis C can be effectively absorbed.

### 3.3. Sound-isolation cover 50

As shown in FIG. 1, the sound-isolation cover 50 includes a first cover 51 attached to the bracket body 30, and a second cover 52 assembled to the first cover 51. In a state where the first cover 51 is attached to the bracket body 30, the first cover 51 opens forward. A lock protrusion 51a protruding outward is formed at a position near the opening edge portion of the outer surface of the first cover 51. A lock receiver 52a that elastically engages with the lock protrusion 51a is formed at a position corresponding to the lock protrusion 51a of the first cover 51 on the outer surface of the second cover 52. The lock receiver 52a is formed in a frame shape.

In the case of the first cover 51 and the second cover 52 approaching each other, the lock receiver 52a rides over the lock protrusion 51a and elastically deforms. In the case of the first cover 51 and the second cover 52 further approaching each other, the lock receiver 52a gets over the lock protrusion 51a and returns to the original shape, and the lock receiver 52a engages with the lock protrusion 51a from behind. Thereby, the first cover 51 and the second cover 52 are assembled. However, the shapes of the lock protrusion 51a and the lock receiver 52a are not limited to the above, and any shapes can be appropriately selected as long as the lock protrusion 51a and the lock receiver are able to engage with each other. Further, the number of the lock protrusions 51a and the lock receivers 52a is not particularly limited. Further, the locations where the lock protrusion 51a and the lock receiver 52a are disposed are not particularly limited, and the lock receiver 52a may be formed on the first cover 51 and the lock protrusion 51a may be formed on the second cover 52.

The first cover 51 includes a first body portion cover 51b that covers the rear half of the body portion 21 of the vehicle electric auxiliary machine 20, a first protruding portion cover 51c that covers the rear half of the protruding portion 22 of the vehicle electric auxiliary machine 20, and a first boss cover 51d that covers the boss 21c and the boss base portion 21b of the vehicle electric auxiliary machine 20.

The second cover 52 includes a second body portion cover 52b that covers the rear half of the body portion 21 of the vehicle electric auxiliary machine 20, a second protruding portion cover 52c that covers the rear half of the protruding portion 22 of the vehicle electric auxiliary machine 20, and a second boss cover 52d that covers the boss 21c and the boss base portion 21b of the vehicle electric auxiliary machine 20.

As shown in FIG. 1 and FIG. 2, the front surface of the third mounting portion 33 of the bracket body 30 is formed in a shape that follows the rear surface of the first body portion cover 51b of the first cover 51. In other words, the curvature of the front surface of the third mounting portion 33 of the bracket body 30 is formed substantially identical to the curvature of the rear surface of the first body portion cover 51b of the first cover 51. However, "substantially identical" includes not only cases where the curvatures are identical but also cases where the curvatures can be recognized as substantially identical even when they are not identical.

The front surface of the third mounting portion 33 of the bracket body 30 and the rear surface of the first body portion cover 51b of the first cover 51 are bonded by an adhesive material. Thereby, the sound-isolation cover 50 is attached to the bracket body 30. In other words, the sound-isolation cover 50 is attached on the first main surface 31a side (front surface side) of the bracket body 30. As the adhesive material, a rigid adhesive material may be used or a soft adhesive material may be used. The adhesive material may have elasticity, viscosity, or viscoelasticity. In the case of the adhesive material having viscosity or viscoelasticity, transmission of vibration from the bracket body 30 to the sound-isolation cover 50 can be further suppressed.

As shown in FIG. 2, a first engagement portion 53a that protrudes rearward is formed on the rear surface of the first cover 51 of the sound-isolation cover 50. Additionally, a second engagement portion 53b that is perforated in the front-rear direction is formed in the third mounting portion 33 of the bracket body 30 at a position corresponding to the first engagement portion 53a. The sound-isolation cover 50 is temporarily fixed to the bracket body 30 by the first engagement portion 53a engaging with the second engagement portion 53b. Thereby, work efficiency in bonding the sound-isolation cover 50 to the bracket body 30 can be improved.

In a state where the first cover 51 and the second cover 52 are assembled, the vehicle electric auxiliary machine 20 is covered by the sound-isolation cover 50 except for a protruding end portion (rear end portion) of the boss 21c. In other words, the protruding end portion of the boss 21c is not covered by the sound-isolation cover 50 and is exposed from the sound-isolation cover 50. In this way, the sound-isolation cover 50 covers at least a part of the vehicle electric auxiliary machine 20 on the first main surface 31a side of the bracket body 30. The protruding end portion of the boss 21c abuts against the first main surface 31a of the first mounting portion 31 of the bracket body 30 from the front. In a state where the protruding end portion of the boss 21c abuts against the first main surface 31a of the first mounting portion 31, the bracket body 30 is fixed to the vehicle electric auxiliary machine 20 by a bolt 36 screwed into the female screw hole 21d.

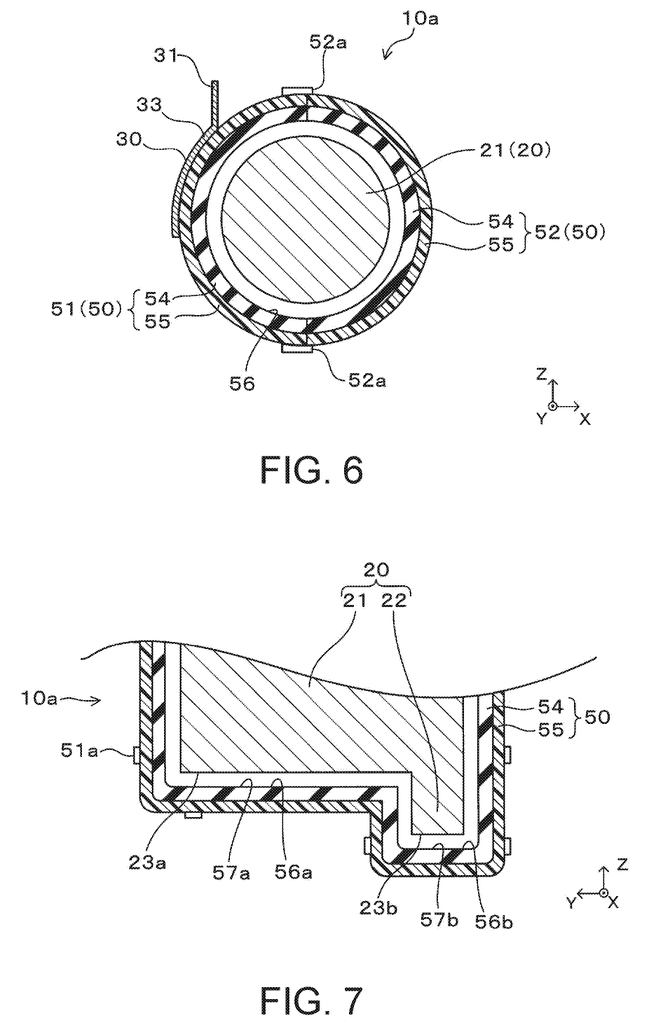

As shown in FIG. 6, in a state where the first cover 51 and the second cover 52 are assembled, the sound-isolation cover 50 includes a sound-isolation layer 54 made of a first foam resin material, and a protective layer 55 made of a second foam resin material having greater hardness than the first foam resin material. The sound-isolation layer 54 is disposed to face the vehicle electric auxiliary machine 20. Further, the protective layer 55 is disposed on the opposite side from the vehicle electric auxiliary machine 20 with reference to the sound-isolation layer 54. However, the protective layer 55 may be omitted.

As the first foam resin material, for example, urethane foam, acrylic foam, silicone foam, styrene foam, foam olefin (foam PP, foam PE), foam PVC, foam EVA, foam PA and the like can be suitably used. The Asker C hardness of the first foam resin material can be 1 to 60 degrees.

The second foam resin material has greater hardness than the first foam resin material. The Asker C hardness of the second foam resin material can be 60 to 99 degrees. The second foam resin material differs from the first foam resin material. For instance, examples of the second foam resin material include urethane foam, acrylic foam, silicone foam, styrene foam, foam olefin (foam PP, foam PE), foam PVC, foam EVA, foam PA and the like. It is noted that even in the case of applying urethane foams to the sound-isolation layer 54 and the protective layer 55, the urethane foams are of different types. Additionally, foam rubber can be used as the second foam resin material, for example. Examples of foam rubber include foam EPDM, foam CR, foam NBR/PVC, foam ACM and the like.

The sound-isolation layer 54 may have a configuration including a thermal conductive material (not shown). This can improve the heat dissipation performance of the sound-isolation layer 54. The thermal conductive material can be configured to extend from the vehicle electric auxiliary machine 20 side of the sound-isolation layer 54 toward the protective layer 55. For example, in the case of the thermal conductive material being a thermal conductive filler, the thermal conductive filler is arranged from the vehicle electric auxiliary machine 20 side of the sound-isolation layer 54 toward the protective layer 55. Furthermore, the filling amount of the thermal conductive material may differ according to the position of the sound-isolation layer 54. It is noted that the filling amount here means the filling amount per unit area in the surface direction of the sound-isolation layer 54.

As shown in FIG. 6 and FIG. 7, a gap 56 is formed between the sound-isolation cover 50 and the vehicle electric auxiliary machine 20. In other words, the sound-isolation cover 50 covers the vehicle electric auxiliary machine 20 in a non-contact state. In the present embodiment, the gap 56 is formed between all surfaces where the inner surface of the sound-isolation cover 50 and the outer surface of the vehicle electric auxiliary machine 20 oppose each other.

As shown in FIG. 7, among the outer surfaces of the vehicle electric auxiliary machine 20, the outer surface of the body portion 21 is a first outer surface 23a, and the outer surface of the protruding portion 22 is a second outer surface 23b. Further, in the sound-isolation cover 50, the portion disposed opposing the first outer surface 23a is a first inner surface 57a, and the portion disposed opposing the second outer surface 23b is a second inner surface 57b. The gap 56 between the first outer surface 23a and the first inner surface 57a is a first gap 56a. In addition, the gap 56 between the second outer surface 23b and the second inner surface 57b is a second gap 56b. In the present embodiment, the first inner surface 57a and the second inner surface 57b are disposed continuously. In other words, the first inner surface 57a and the second inner surface 57b are in communication.

As shown in FIG. 6, the bonding area where the sound-isolation cover 50 and the bracket body 30 are bonded is smaller than the opposing area where the sound-isolation cover 50 and the vehicle electric auxiliary machine 20 oppose each other. This will be described in detail below.

As shown in FIG. 6, in the present embodiment, at least the inner surface of the sound-isolation cover 50 opposes all outer surfaces of the body portion 21 of the vehicle electric auxiliary machine 20. On the other hand, the bonding area where the sound-isolation cover 50 and the bracket body 30 are bonded is set smaller than the entire circumference of the outer surface of the sound-isolation cover 50. The bonding area where the sound-isolation cover 50 and the bracket body 30 are bonded can be set to any value within a range of 5% to 90% relative to the entire circumference of the outer surface of the sound-isolation cover 50. Furthermore, the bonding area where the sound-isolation cover 50 and the bracket body 30 are bonded is preferably set to any value within a range of 10% to 50% relative to the entire circumference of the outer surface of the sound-isolation cover 50.

### 4. Example of manufacturing process of the present embodiment

Next, an example of the manufacturing process of the vibration-isolation and sound-isolation apparatus 10a according to the present embodiment will be described with reference to FIG. 1, FIG. 2, and FIG. 5. However, the manufacturing process of the vibration-isolation and sound-isolation apparatus 10a is not limited to the following description.

The bracket body 30 is formed into a predetermined shape by bending a metal plate material.

The first cover 51 and the second cover 52 are formed by molding a synthetic resin material.

An adhesive material is applied to the first cover 51 and the bracket body 30. The first engagement portion 53a of the first cover 51 and the second engagement portion 53b of the bracket body 30 are engaged with each other. Thereby, the first cover 51 and the bracket body 30 are bonded in a positioned state. As a result, a component in which the bracket body 30 and the first cover 51 are assembled can be obtained (see FIG. 1).

Next, as shown in FIG. 5, a part of the vehicle electric auxiliary machine 20 is covered with the first cover 51. The vehicle electric auxiliary machine 20 is fixed to the bracket body 30 by screwing the bolt 36 into the female screw hole 21d of the boss 21c of the vehicle electric auxiliary machine 20.

Next, as shown in FIG. 2, the first cover 51 and the second cover 52 are assembled by engaging the lock protrusion 51a and the lock receiver 52a with each other. Through the above process, the vibration-isolation and sound-isolation apparatus 10a is completed.

### 5. Operation and effect of the present embodiment

Next, the operation and effect of the present embodiment will be described. The vibration-isolation and sound-isolation apparatus 10a according to the present embodiment includes the bracket body 30, the vibration-isolation device 40, and the sound-isolation cover 50. The bracket body 30 is attached to the vehicle electric auxiliary machine 20. The vibration-isolation device 40 is attached to the bracket body 30 and elastically connects the bracket body 30 and the vehicle body B of the vehicle. The sound-isolation cover 50 is attached to the bracket body 30, the vibration-isolation device 40, or the vehicle electric auxiliary machine 20 and covers the vehicle electric auxiliary machine 20 in a non-contact state.

Moreover, the fixing structure for the vehicle electric auxiliary machine 20 according to the present embodiment is configured to fix the vehicle electric auxiliary machine 20 to the vehicle body B of the vehicle using the above-described vibration-isolation and sound-isolation apparatus 10a.

According to the present embodiment, vibration generated by operation of the vehicle electric auxiliary machine 20 is transmitted from the vehicle electric auxiliary machine 20 to the bracket body 30, and then attenuated by the vibration-isolation device 40 attached to the bracket body 30. This suppresses transmission of vibration generated in the vehicle electric auxiliary machine 20 to the vehicle body B of the vehicle.

Furthermore, sound generated by operation of the vehicle electric auxiliary machine 20 is absorbed by the sound-isolation cover 50 that covers the vehicle electric auxiliary machine 20.

Since the sound-isolation cover 50 and the vehicle electric auxiliary machine 20 are in a non-contact state, transmission of vibration from the vehicle electric auxiliary machine 20 to the sound-isolation cover 50 is suppressed. This suppresses generation of sound from the sound-isolation cover 50 due to vibration transmitted from the vehicle electric auxiliary machine 20.

Further, according to the present embodiment, the gap 56 is formed between all surfaces where the inner surface of the sound-isolation cover 50 and the outer surface of the vehicle electric auxiliary machine 20 oppose each other. This can further suppress transmission of vibration from the vehicle electric auxiliary machine 20 to the sound-isolation cover 50.

Moreover, the bracket body 30 according to the present embodiment is attached to a portion of the vehicle electric auxiliary machine 20 that is not covered by the sound-isolation cover 50. The vehicle electric auxiliary machine 20 is relatively heavy. Therefore, it is desirable to attach the vehicle electric auxiliary machine 20 relatively firmly to the bracket body 30. According to the present embodiment, the sound-isolation cover 50 does not intervene between the bracket body 30 and the vehicle electric auxiliary machine 20, making it possible to firmly mount the bracket body 30 and the vehicle electric auxiliary machine 20.

Further, the bracket body 30 according to the present embodiment has the first main surface 31a that is attached to the vehicle electric auxiliary machine 20, and the sound-isolation cover 50 covers at least a part of the vehicle electric auxiliary machine 20 on the first main surface 31a side of the bracket body 30. This enables the sound-isolation cover 50 to suppress transmission of at least part of the noise emitted from the vehicle electric auxiliary machine 20 to the outside.

The sound-isolation cover 50 according to the present embodiment is attached to the bracket body 30 by an adhesive material. This can maintain the sound-isolation cover 50 and the vehicle electric auxiliary machine 20 in a non-contact state.

It is conceivable that vibration generated by operation of the vehicle electric auxiliary machine 20 may be transmitted to the bracket body 30 to which the vehicle electric auxiliary machine 20 is attached, and transmitted to the sound-isolation cover 50 attached to this bracket body 30. It is also conceivable that vibration generated by operation of the vehicle electric auxiliary machine 20 may be directly transmitted to the sound-isolation cover 50 that covers the vehicle electric auxiliary machine 20. In the present embodiment, the bonding area where the sound-isolation cover 50 and the bracket body 30 are bonded is smaller than the opposing area where the sound-isolation cover 50 and the vehicle electric auxiliary machine 20 oppose each other. Therefore, the vibration transmitted from the vehicle electric auxiliary machine 20 to the sound-isolation cover 50 is less in the case of transmission via the bracket body 30 than in the case of direct transmission from the vehicle electric auxiliary machine 20 to the sound-isolation cover 50. Furthermore, in the present embodiment, the vehicle electric auxiliary machine 20 is in a non-contact state, so direct transmission of vibration from the vehicle electric auxiliary machine 20 to the sound-isolation cover 50 is suppressed. As a result, vibration transmitted from the vehicle electric auxiliary machine 20 to the sound-isolation cover 50 can be further reduced.

The bracket body 30 according to the present embodiment includes the first mounting portion 31 and the second mounting portion 32. The first mounting portion 31 has the first main surface 31a that is attached to the vehicle electric auxiliary machine 20, and is disposed such that the first main surface 31a opposes the vehicle electric auxiliary machine 20. The second mounting portion is formed integrally with the first mounting portion 31 and is attached to the vehicle body B. The second mounting portion 32 is disposed on the first main surface 31a side of the first mounting portion 31. Since the vehicle electric auxiliary machine 20 is relatively heavy, disposing the second mounting portion 32 on the first main surface 31a side can firmly support the vehicle electric auxiliary machine 20.

The vehicle electric auxiliary machine 20 according to the present embodiment includes the rotating shaft member 21a. The bracket body 30 includes the first mounting portion 31 and multiple second mounting portions 32. The first mounting portion 31 extends in the rotation axis C direction of the rotating shaft member 21a, has the first main surface 31a that is attached to the vehicle electric auxiliary machine 20, and is disposed such that the first main surface 31a opposes the vehicle electric auxiliary machine 20. The multiple second mounting portions 32 are formed integrally with the first mounting portion 31 and are attached to the vehicle body B. At least one of the multiple second mounting portions 32 is disposed on one end side in the rotation axis C direction of the rotating shaft member 21a with respect to the vehicle electric auxiliary machine 20. This can improve the vibration isolation performance of the vibration-isolation and sound-isolation apparatus 10a.

Furthermore, according to the present embodiment, at least another one of the multiple second mounting portions 32 is disposed on the other end side in the rotation axis C direction of the rotating shaft member 21a with respect to the vehicle electric auxiliary machine 20. This can further improve the vibration isolation performance of the vibration-isolation and sound-isolation apparatus 10a.

The sound-isolation cover 50 according to the present embodiment includes the sound-isolation layer 54 made of a first foam resin material. This can further improve the vibration isolation performance of the vibration-isolation and sound-isolation apparatus 10a.

The sound-isolation cover 50 according to the present embodiment includes the sound-isolation layer 54 and the protective layer 55. The sound-isolation layer 54 is disposed opposing the vehicle electric auxiliary machine 20. The protective layer 55 is made of a second foam resin material having greater hardness than the first foam resin material and is disposed on the opposite side of the sound-isolation layer 54 from the vehicle electric auxiliary machine 20. This can protect the sound-isolation layer 54 and maintain the shape of the sound-isolation layer 54.

The vibration-isolation and sound-isolation apparatus 10a (bracket with a vibration-isolation and sound-isolation function) according to the present embodiment includes the bracket body 30, the sound-isolation cover 50, and the vibration-isolation device 40. The bracket body 30 has the first main surface 31a to which the vehicle electric auxiliary machine 20 is attached. The sound-isolation cover 50 is attached to the bracket body 30 and covers at least a part of the vehicle electric auxiliary machine 20 on the first main surface 31a side of the bracket body 30. The vibration-isolation device 40 is attached to the bracket body 30 and elastically connects the bracket body 30 and the vehicle body B of the vehicle.

According to the present embodiment, the bracket body 30, the vibration-isolation device 40, and the sound-isolation cover 50 can be handled as one component, so the number of parts can be reduced compared to a case where the bracket body 30, the vibration-isolation device 40, and the sound-isolation cover 50 are handled as separate components.

### Embodiment 2

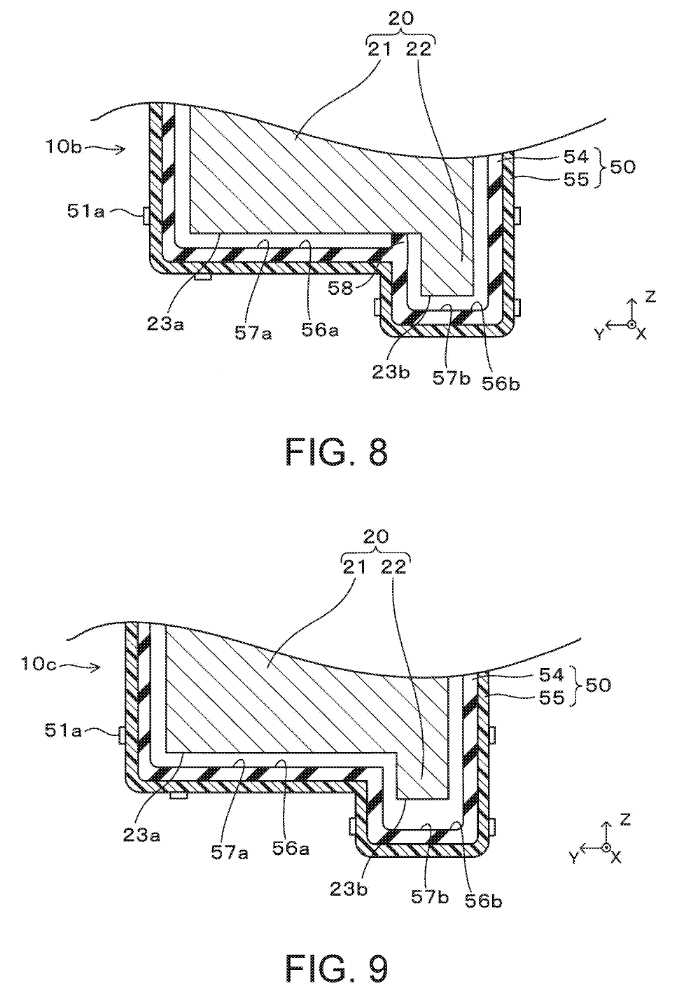

Next, a vibration-isolation and sound-isolation apparatus 10b according to Embodiment 2 will be described with reference to FIG. 8. In the present embodiment, a protruding wall 58 that protrudes from the sound-isolation layer 54 toward the body portion 21 is formed between the first inner surface 57a and the second inner surface 57b of the sound-isolation cover 50. The tip portion of the protruding wall 58 abuts against the outer surface of the body portion 21 of the vehicle electric auxiliary machine 20. Thereby, the first inner surface 57a and the second inner surface 57b of the sound-isolation cover 50 are discontinuously arranged by the protruding wall 58.

It is noted that the reference numerals used in Embodiment 2 and subsequent embodiments, which are identical to the reference numerals used in the previously described embodiment, represent the same components as those in the previously described embodiment, unless otherwise specified.

### Embodiment 3

Next, a vibration-isolation and sound-isolation apparatus 10c according to Embodiment 3 will be described with reference to FIG. 9. In the present embodiment, the dimension of the first gap 56a differs from the dimension of the second gap 56b. In the present embodiment, the first gap 56a has a smaller dimension than the second gap 56b. However, the first gap 56a may have a larger dimension than the second gap 56b.

Nevertheless, the thickness of the sound-isolation cover 50 may differ between a region that forms the first gap 56a and a region that forms the second gap 56b.

### Embodiment 4

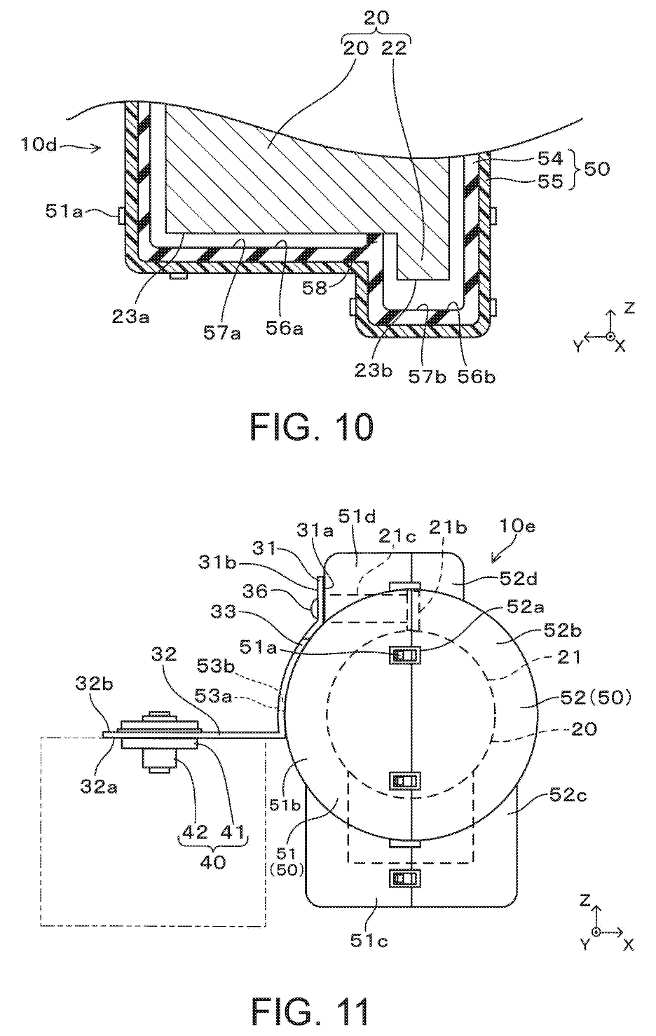

Next, a vibration-isolation and sound-isolation apparatus 10d according to Embodiment 4 will be described with reference to FIG. 10. In the present embodiment, the first inner surface 57a and the second inner surface 57b of the sound-isolation cover 50 are discontinuously arranged by the protruding wall 58. Further, in the present embodiment, the dimension of the first gap 56a differs from the dimension of the second gap 56b.

### Embodiment 5

Next, a vibration-isolation and sound-isolation apparatus 10e according to Embodiment 5 will be described with reference to FIG. 11. In the present embodiment, the first main surface 31a and the second main surface 32a constitute surfaces on the same side of the bracket body 30, and the first main surface 31a and the second main surface 32a are connected at an angle.

### Embodiment 6

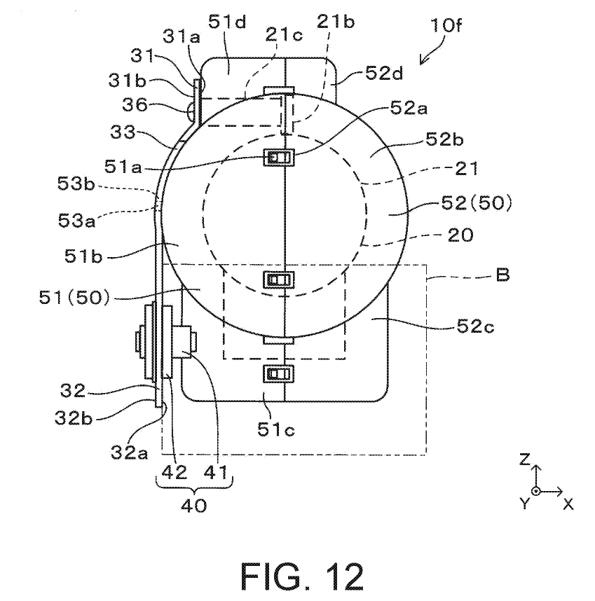

Next, a vibration-isolation and sound-isolation apparatus 10f according to Embodiment 6 will be described with reference to FIG. 12. In the present embodiment, the first main surface 31a and the second main surface 32a constitute surfaces on the same side of the bracket body 30, and the first main surface 31a and the second main surface 32a constitute a smoothly continuous surface.

### Embodiment 7

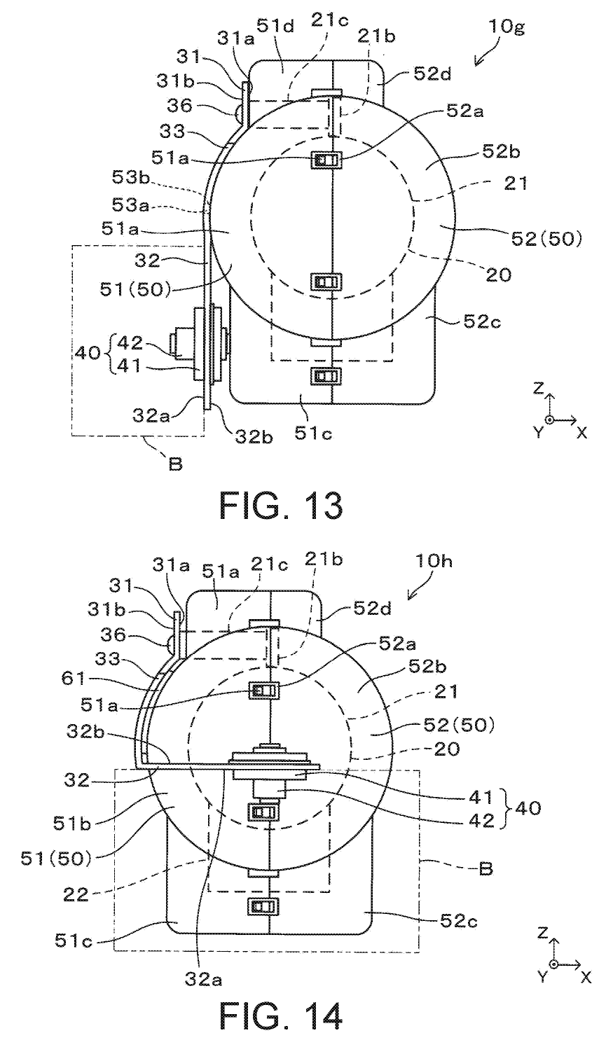

Next, a vibration-isolation and sound-isolation apparatus 10g according to Embodiment 7 will be described with reference to FIG. 13. In the present embodiment, the first main surface 31a and the second main surface 32a constitute surfaces on the opposite sides of the bracket body 30, and the first main surface 31a and the second back surface 32b constitute a smoothly continuous surface.

### Embodiment 8

Next, a vibration-isolation and sound-isolation apparatus 10h according to Embodiment 8 will be described with reference to FIG. 14. In the present embodiment, the sound-isolation cover 50 is attached to the third mounting portion 33 of the bracket body 30 via a vibration-isolation member 61. The vibration-isolation member 61 is preferably made of a material having excellent vibration isolation performance, for example, foam resin. As examples of foam resin, urethane foam, acrylic foam, silicone foam, styrene foam, foam olefin (foam PP, foam PE), foam PVC, foam EVA, foam PA and the like are applied. The vibration-isolation member 61 may be made of non-foam resin having vibration isolation performance, or may be made of metal. As examples of non-foam resin, polyamide resin, olefin resin, styrene resin, urethane resin, silicone resin, acrylic resin, polyvinyl chloride resin, polyethylene resin, polyethylene terephthalate resin, polycarbonate resin, polypropylene resin, ABS resin, EVA resin, carbon fiber plastic (FRP, CFRP) and the like are applied. Further, as examples of metal, iron, aluminum, SUS, copper, and alloys thereof are applied.

According to the present embodiment, vibration generated in the vehicle electric auxiliary machine 20 and transmitted to the bracket body 30 can be suppressed from being transmitted from the bracket body 30 to the sound-isolation cover 50. This can suppress the sound-isolation cover 50 from generating noise due to the transmitted vibration.

Nevertheless, the bracket body 30 and the sound-isolation cover 50 may be connected by the above-described vibration-isolation device 40. For example, a configuration in which the bracket body 30 is connected to the outer cylinder 41 of the vibration-isolation device 40 and the sound-isolation cover 50 is connected to the inner cylinder 42 of the vibration-isolation device 40 can suppress transmission of vibration from the bracket body 30 to the sound-isolation cover 50.

### Embodiment 9

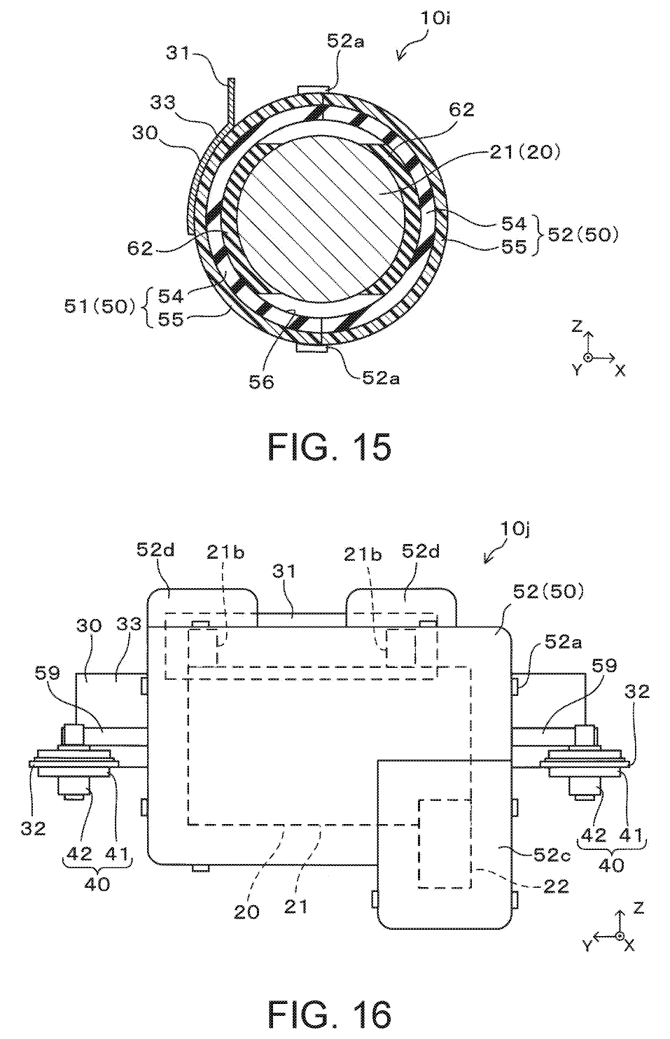

Next, a vibration-isolation and sound-isolation apparatus 10i according to Embodiment 9 will be described with reference to FIG. 15. In the present embodiment, the sound-isolation cover 50 is attached to the vehicle electric auxiliary machine 20 via a vibration-isolation member 62. This can further suppress transmission of vibration from the vehicle electric auxiliary machine 20 to the sound-isolation cover 50.

### Embodiment 10

Next, a vibration-isolation and sound-isolation apparatus 10j according to Embodiment 10 will be described with reference to FIG. 16 to FIG. 18. As shown in FIG. 16, in the present embodiment, the sound-isolation cover 50 is connected to the inner cylinder 42 of the vibration-isolation device 40 via a connecting member 59. The connecting member 59 is formed protruding from the sound-isolation cover 50 toward the inner cylinder 42 of the vibration-isolation device 40. The connecting member 59 is attached to the inner cylinder 42 by known methods such as adhesion, thermal welding, and screwing.

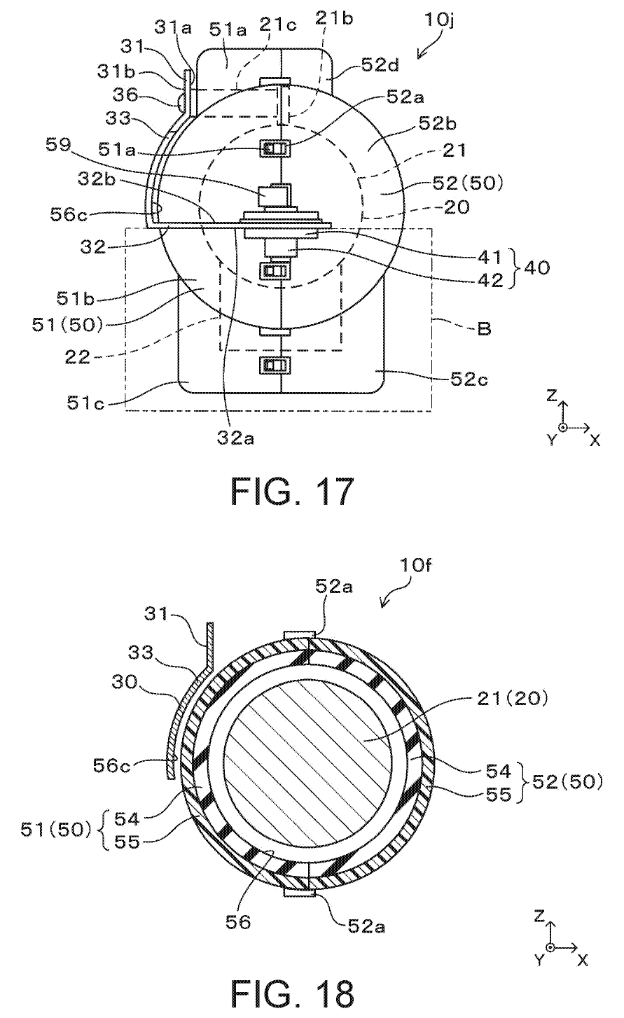

As shown in FIG. 17 and FIG. 18, in the present embodiment, a gap 56c is formed between the third mounting portion 33 of the bracket body 30 and the sound-isolation cover 50. In other words, the third mounting portion 33 of the bracket body 30 and the sound-isolation cover 50 are not in contact with each other. This suppresses transmission of vibration from the third mounting portion 33 of the bracket body 30 to the sound-isolation cover 50.

Vibration generated in the vehicle electric auxiliary machine 20 is transmitted to the bracket body 30. The vibration transmitted to the bracket body 30 is transmitted from the bracket body 30 to the outer cylinder 41 of the vibration-isolation device 40 and is absorbed by the elastic body 43. Thereby, the vibration transmitted to the inner cylinder 42 of the vibration-isolation device 40 is attenuated. Since the sound-isolation cover 50 is attached to this inner cylinder 42, transmission of vibration generated in the vehicle electric auxiliary machine 20 to the sound-isolation cover 50 can be suppressed.

The disclosure is not limited to the above embodiments, and can be applied to various embodiments within a range that does not depart from the gist of the disclosure.

1. A vibration-isolation and sound-isolation apparatus, attached to a vehicle electric auxiliary machine, the vibration-isolation and sound-isolation apparatus comprising:
a bracket body attached to the vehicle electric auxiliary machine;
a vibration-isolation device attached to the bracket body and elastically connecting the bracket body and a vehicle body of a vehicle; and
a sound-isolation cover attached to the bracket body, the vibration-isolation device, or the vehicle electric auxiliary machine and covering the vehicle electric auxiliary machine in a non-contact state.

2. The vibration-isolation and sound-isolation apparatus according to claim 1, further comprising a gap formed between all surfaces where an inner surface of the sound-isolation cover and an outer surface of the vehicle electric auxiliary machine oppose each other.

3. The vibration-isolation and sound-isolation apparatus according to claim 1, wherein the bracket body is attached to a portion of the vehicle electric auxiliary machine that is not covered by the sound-isolation cover.

4. The vibration-isolation and sound-isolation apparatus according to claim 1, wherein the bracket body has a first main surface attached to the vehicle electric auxiliary machine, and
the sound-isolation cover covers at least a part of the vehicle electric auxiliary machine on the first main surface side of the bracket body.

5. The vibration-isolation and sound-isolation apparatus according to claim 1, wherein the sound-isolation cover is attached to the bracket body.

6. The vibration-isolation and sound-isolation apparatus according to claim 5, wherein the sound-isolation cover is attached to the bracket body by an adhesive material.

7. The vibration-isolation and sound-isolation apparatus according to claim 5, wherein the sound-isolation cover is attached to the bracket body via a vibration-isolation member.

8. The vibration-isolation and sound-isolation apparatus according to claim 5, further comprising a bonding area where the sound-isolation cover and the bracket body are bonded, which is smaller than an opposing area where the sound-isolation cover and the vehicle electric auxiliary machine oppose each other.

9. The vibration-isolation and sound-isolation apparatus according to claim 1, wherein the vibration-isolation device comprises:
an outer cylinder attached to the bracket body;
an inner cylinder disposed inside the outer cylinder and attached to the vehicle body; and
an elastic body connecting the outer cylinder and the inner cylinder,
wherein the sound-isolation cover is attached to the inner cylinder of the vibration-isolation device.

10. The vibration-isolation and sound-isolation apparatus according to claim 1, wherein the sound-isolation cover is attached to the vehicle electric auxiliary machine via a vibration-isolation member.

11. The vibration-isolation and sound-isolation apparatus according to claim 1, wherein the bracket body comprises:
a first mounting portion having a first main surface attached to the vehicle electric auxiliary machine, and disposed such that the first main surface opposes the vehicle electric auxiliary machine; and
a second mounting portion formed integrally with the first mounting portion and attached to the vehicle body,
wherein the second mounting portion is disposed on the first main surface side of the first mounting portion.

12. The vibration-isolation and sound-isolation apparatus according to claim 1, wherein the vehicle electric auxiliary machine comprises a rotating shaft member, and
the bracket body comprises:
a first mounting portion extending in a rotation axis direction of the rotating shaft member, having a first main surface attached to the vehicle electric auxiliary machine, and disposed such that the first main surface opposes the vehicle electric auxiliary machine; and
a plurality of second mounting portions formed integrally with the first mounting portion and attached to the vehicle body,
wherein at least one of the plurality of second mounting portions is disposed on one end side in the rotation axis direction of the rotating shaft member with respect to the vehicle electric auxiliary machine.

13. The vibration-isolation and sound-isolation apparatus according to claim 12, wherein at least another one of the plurality of second mounting portions is disposed on the other end side in the rotation axis direction of the rotating shaft member with respect to the vehicle electric auxiliary machine.

14. The vibration-isolation and sound-isolation apparatus according to claim 1, wherein the sound-isolation cover comprises a sound-isolation layer made of a first foam resin material.

15. The vibration-isolation and sound-isolation apparatus according to claim 14, wherein the sound-isolation cover comprises:
the sound-isolation layer disposed opposing the vehicle electric auxiliary machine; and
a protective layer made of a second foam resin material having greater hardness than the first foam resin material and disposed on an opposite side of the sound-isolation layer from the vehicle electric auxiliary machine.

16. A fixing structure for a vehicle electric auxiliary machine, using the vibration-isolation and sound-isolation apparatus according to claim 1.

17. A bracket with a vibration-isolation and sound-isolation function, attached to a vehicle electric auxiliary machine, the bracket with a vibration-isolation and sound-isolation function comprising:
a bracket body having a first main surface to which the vehicle electric auxiliary machine is attached;
a sound-isolation cover attached to the bracket body and covering at least a part of the vehicle electric auxiliary machine on the first main surface side of the bracket body; and
a vibration-isolation device attached to the bracket body and elastically connecting the bracket body and a vehicle body of a vehicle.

18. The bracket with a vibration-isolation and sound-isolation function according to claim 17, wherein the bracket body comprises:
a first mounting portion having the first main surface attached to the vehicle electric auxiliary machine, and disposed such that the first main surface opposes the vehicle electric auxiliary machine; and
a second mounting portion formed integrally with the first mounting portion and attached to the vehicle body.

19. The bracket with a vibration-isolation and sound-isolation function according to claim 18, wherein the vehicle electric auxiliary machine comprises a rotating shaft member, and
the bracket body comprises:
a plurality of the second mounting portions,
wherein at least one of the plurality of second mounting portions is disposed on one end side in a rotation axis direction of the rotating shaft member with respect to the vehicle electric auxiliary machine, and
at least another one of the plurality of second mounting portions is disposed on the other end side in the rotation axis direction of the rotating shaft member with respect to the vehicle electric auxiliary machine.
